(19) United States
(12) Patent Application Publication
(10) Pub. No.: US 2005/0182847 A1
(43) Pub. Date: Aug. 18, 2005

(54) System and method for dynamic switching between wireless network protocols

(75) Inventors: Fahd Bin Jawad Pirzada, Austin, TX (US); David Reiner, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 10/761,783

(22) Filed: Jan. 21, 2004

(51) Int. Cl. G06F 15/16

(52) U.S. Cl. 709/233; 709/234

(57) ABSTRACT

A system and method for dynamically switching between network includes a receiver module, a performance data module and a dynamic switching module. The receiver module is able to receive communications from at least two network protocols. The performance data module is associated with the receiver module and is able to obtain network performance data for the at least two network protocols. The dynamic switching module is associated with the performance data module and is able to dynamically switch between network protocols based on the network performance data.

### TECHNICAL FIELD

The present disclosure relates in general to information handling systems and network communications and more particularly to a system and method for dynamically switching between different wireless network protocols.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems connected to a network provide greater access to data and processing resources and facilitate the exchange of information. Some networks, such as a wireless local area network, allow an information handling system to have network access without a physical connection to the network.

Wireless networks typically include transmission nodes that emit communication signals that may be received by the information handling system, often a portable or laptop-type computer. The information handling system includes hardware and software that enables the information handling system to communicate with the wireless network.

Currently there are several wireless network protocols for wireless local area networks which all have advantages and disadvantages. For example, 802.11a is a network protocol that has the advantage of high sustained throughputs but also has the disadvantage of having a relatively short transmission range. Another protocol, 802.11b, has a lower throughput as compared to 802.11a, but has a wider transmission range.

Current methods and systems of wireless communication set an initial network protocol and switch to another network protocol only after the initial protocol is no longer available. During the operation of the information handling system, wireless communication using the initial protocol continues if the information handling system changes its physical location or if an outside interference disturbs the initial wireless network protocol. This often results in continued communication using the communication protocol initially set at less than optimal efficiency due to a reduction in signal quality or signal strength. This continued use of the initial network protocol may result in a number of disadvantages to the user. For example a user who is using the wireless network for a bandwidth intensive application such as receiving multimedia streaming may find the chosen network protocol to be ineffective for the application. In other situations, the overall efficiency of the information handling system may be negatively effected by a reduction in signal strength or signal quality.

### SUMMARY

Therefore, a need has arisen for a system and method for optimizing wireless network performance in a multi-protocol environment.

Further, a need has arisen for a system and method that facilitates dynamic switching between network protocols during a wireless communication session based on the performance characteristics of different network protocols available to the system.

In accordance with teachings of the present disclosure, a system and method are described for dynamically switching between wireless network protocols that substantially reduces disadvantages and problems associated with previously developed network protocol setting systems and methods. The system includes a dynamic switching module able to monitor performance data and dynamically switch between network protocols, thereby optimizing network performance characteristics.

In one aspect, an information handling system includes a receiver module, a performance data module and a dynamic switching module. The receiver module may receive communications according to two or more network protocols. The performance data module is connected with the receiver module and may obtain network performance data for each of the network protocols. The dynamic switching module is connected with the performance data module and may monitor network performance data and dynamically switch between network protocols based on the network performance data.

In another aspect of the present disclosure, a method of dynamically switching between network protocols includes conducting network communications from a client system via a first network protocol. The method receives performance data for the first network protocol. The method also receives performance data for a second network protocol. The method then determines whether switching from the first network protocol to the second network protocol would improve performance for the client system. Upon determining that switching to the second network protocol would cause improved performance, the method automatically switches from the first network protocol to the second network protocol.

The present invention provides a number of important technical advantages. One technical advantage is providing a dynamic switching module able to monitor performance data and dynamically switch between wireless network protocols based on performance data. This allows a user to take advantage of the best wireless network protocol available. Further advantages of the present disclosure are described in the description, FIGURES and claims.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 shows an information handling system and multiple wireless access points providing communications according to different wireless network protocols;

FIG. 2 is an information handling system including a performance data module and dynamic switching module according to teachings of the present disclosure;

FIG. 3 shows a wireless network access card according to teachings of the present disclosure;

FIG. 4 shows a graphical representation showing the throughput of different wireless network protocols as a function of distance; and

FIG. 5 shows a flow diagram showing a method for determining improved performance of available wireless network protocols and dynamic switching according to teachings of the present disclosure.

### DETAILED DESCRIPTION

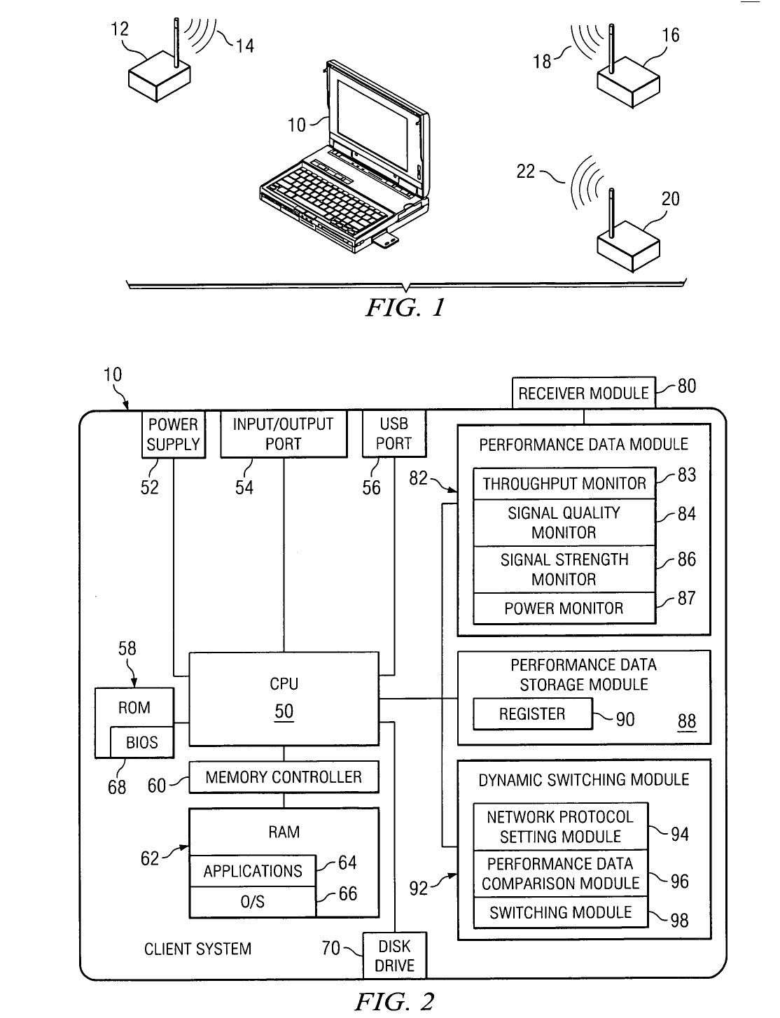

Preferred embodiments and their advantages are best understood by reference to FIGS. 1 through 5, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a personal digital assistant, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Now referring to FIG. 1, a client system 10 is shown in relation to first wireless access point 12, a second wireless access point 16 and a third wireless access point 20. In the present embodiment client system 10 is a laptop computer. In alternate embodiments client system 10 may be any information handling system able to communicate via wireless communication through multiple wireless network protocols. In the present embodiment first wireless access point 12 is able to broadcast and receive communications via a first wireless network protocol 14. A second wireless access point 16 is able to send and receive communications via a second wireless network protocol 18. A third wireless access point 20 is able to send and receive communications broadcast via a third wireless network protocol 22. Further, wireless access points 12, 16, and 20 operate to provide access to a common communication network. In the present embodiment first wireless network protocol 14 is wireless network protocol 802.11a, second wireless network protocol 18 is wireless network protocol 802.11b, and third wireless network protocol 22 is wireless network protocol 802.11g. In alternate embodiments, wireless network protocols 14, 18, and 22 may be any wireless network protocol suitable for communication with client system 10.

In operation client system 10 may conduct network communications with any of wireless access points 12, 16 and 20. Further, client system 10 is able to dynamically switch between wireless communication protocols 14, 18 and 22 as described below.

Now referring to FIG. 2, a diagram of client system 10 is shown. In the present embodiment, client system 10 includes central processing unit (CPU) 50 connected with power supply 52, input/output port 54, USB port 56, read only memory (ROM) 58, memory controller 60, disk drive 70 as well as performance data module 82, performance data storage module 88 and dynamic switching module 92. Power supply 52 supplies power to client system 10. Input/output port 54 and universal serial bus (USB) port 56 allow client system to physically connect with additional components or with other systems. CPU 50 functions to interpret and execute instructions within the system. ROM 58 is a memory component that contains instructions or data that can be read by CPU 50, but not modified. ROM 58 includes basic input/output system (BIOS) 68. BIOS 68 encompasses software routines that tests hardware at start up, starts operating system 66 and supports the transfer of data among hardware devices.

Memory controller 60 controls the management and storage of data to random access memory (RAM) 62. In the present embodiment RAM 62 is a volatile, semiconductor-based memory that can be read and written by CPU 50. RAM 62 stores operating system 66 and applications 64. Operating system 66 controls the allocation and usage of memory, processing resources, and peripheral devices associated with client system 10. Applications 64 may include any suitable programs or software applications loaded for use by client system 10.

Disk drive 70 is connected with CPU and allows for additional memory storage. In the present embodiment disk drive 70 is a hard disk drive, however, in alternate embodiments client system 10 may include additional disk drives.

In the present embodiment client system 10 includes performance data module 82, performance data storage module 88 and the dynamic switching module 92, all generally in communication with CPU 50. Performance data module 82 is in communication with receiver module 80; receiver module 80 operates to receive wireless network communications according to multiple (at least two) wireless network protocols. In the present embodiment receiver module 80 is able to receive wireless communications according to wireless network protocols 802.11a, 802.11b as well as 802.11g. Additionally, the present disclosure contemplates receiver module 80 able to receive communications according to additional suitable wireless network protocols.

Performance data module 82 includes throughput monitor 83, signal quality monitor 84, signal strength monitor 86 and power monitor 87. Generally, performance data module 82 is able to obtain network performance data from receiver module 80 and recording to two or more different wireless network protocols. More specifically, communications data throughput monitor 83 received by receiver module 80 is monitored by performance data module 82. Throughput monitor 83 determines the current throughput of available wireless network protocols. Signal quality monitor 84 reads or determines the signal quality associated with communications received by receiver module 80 and recording to a particular wireless network indication protocol.

For example, signal quality may be measured by utilizing a Signal Quality Indicator (SQI). SQI, as known in the art, is often used in applications such as antenna switching in wireless devices that use antenna diversity. SQI calculations generally provide a measure of signal clarity based on variables such as signal-to-noise ratio, delay spread and bit error rates. Signal strength indicator 86 measures signal strength (for instance, signal strength may be the power of the received signal expressed in dBm (1 milliwatt=0 dBm)).

Another metric that may be used to gauge signal quality is Signal-to-Noise ratio (SNR). SNR is typically measured in dB and shows the relative strength of the signal in the presence of channel noise. Most networking chipsets allow the tracking of these factors. The device driver can be used to extract this information from the device registers.

Similarly, signal strength monitor 86 monitors communications received by receiver module 80 and determines the signal strength of communications according to a particular wireless network protocol. Power monitor 87 function to monitor the power usage of client system 10 while using particular wireless network protocols.

Energy consumption while using a certain protocol with a certain data rate is predetermined by calculating the current draw from client system 10. This data may then be stored in power module 87 and can be used to determine the most power-efficient protocol for a particular scenario. In a preferred embodiment, the user may control power module 87 to allow the choice of various power saving schemes. For example, if the user requires extended battery life, the power module 87 may direct the system to switch to the most power-efficient protocol regardless of throughput and signal performance. On the contrary, if the user requires better throughput performance, the power module allows switching to the best protocol regardless of energy conservation considerations.

Performance data storage module 88 includes register 90. In the present embodiment, performance data storage module 88 stores performance data (including signal quality and signal strength) associated with wireless network communication protocols that are received by receiver module 80 and stores that data within register 90.

Preferably, performance data storage module 88 register 90 includes a separate register for each type of available wireless network communication protocol (such as wireless communication protocols 14, 18 and 22 as described above) and each network performance factor being monitored. Register 90 of performance data storage module 88 may be accessed by dynamic switching module 92. Dynamic switching module 92 includes network protocol setting module 94, performance data comparison module 96 and switching module 98. Network protocol setting module 94 determines which wireless network communication protocol will be used in the transmission and communication of data between client system 10 and a wireless network via a wireless access point (such as wireless access point 12, 16 or 20).

Performance data comparison module 96 is able to interface with performance data module 82 and performance data storage module 88 and can compare the performance data (including, but not limited to, throughput, signal quality, signal strength and energy consumption) associated with different available wireless network protocols. Switching module 98 is operable to determine whether switching to a particular wireless network protocol would provide better performance for wireless communications for client system 10. Switching module 98 also initiates switching of the network protocol setting of network protocol setting module 94 to a more advantageous network protocol. In alternate embodiments, the functions of network protocol setting module 94, performance data comparison module 96 and switching module 98 may be aggregated and performed within a single dynamic switching module 92.

In some embodiments, switching module 98 may include upper and/or lower threshold values for throughput, signal quality, or signal strength. Switching module 98 may then use the threshold values to determine whether to switch network protocol settings. In this manner, switching module 98 will not initiate a change of wireless network protocols until a performance factor value falls below (or exceeds, as appropriate) a threshold value. This use of threshold values should help prevent unnecessary switching. For example, during many typical uses of client system 10, the most effective wireless network protocol for client system 10 (where multiple wireless network protocols are available) will depend on client system 10's proximity to various access points. Often, users will work in a single location for an extended period before moving to a new location. The use of upper and lower threshold settings will prevent unnecessary switching due to minor or temporary changes from different access points, especially while client system 10 is stationary.

In other embodiments, switch module 98 may evaluate existing available network protocols periodically to determine whether a more effective wireless network protocol is available. Some embodiments may use both threshold setting and periodic evaluations, providing a reliable, low overhead switching mechanism.

Multiple indicators (such as packets sent, packets received, packets lost, packet error rate, packet retransmission rate, etc) may be used to gauge the throughput performance of each available protocol. This information coupled with the existing data rate (for example, 5.5 Mbps, 11 Mbps or 54 Mbps etc.) can be used to calculate throughput for a given protocol.

In one instance, client system 10 may be able to receive two transmissions of similar signal strength and quality. In another instance the network protocol providing a better signal strength and quality may be overloaded with traffic while another network protocol with lower signal strength and quality might guarantee better throughput. In such scenarios, throughput monitor 83 can monitor variables such as Contention Window Size (CW) of the 802.11 protocol to determine which protocol guarantees the best throughput characteristics. CW defines the time that a client device waits before it contends for a channel. Initially client system 10 picks a random CW but if the initial attempt fails, the CW size is doubled. Accordingly, the CW size monitored over a period of time can provide a measure of network traffic on a certain channel.

During operation, receiver module 80 of client system 10 receives communications broadcast via different network protocols such as network protocols 14, 18 and 22. As communications according to different network protocols are received, the performance associated with each protocol is evaluated using signal throughput monitor 83, signal quality monitor 84 and signal strength monitor 86. After determining the relative throughput, signal quality and signal strength of available wireless network protocols, the throughput signal quality and signal strength for each network protocol may be stored periodically within performance data storage module 88.

Dynamic switching module 92 may then access performance data storage module 88 and the information stored therein as well as the current throughput, signal quality and signal strength information determined by performance data module 82. Performance data comparison module 96 may then compare the current wireless network protocol with one or more other available wireless network protocols. Switching module 98 then determines whether to switch from the current wireless network protocol to a different wireless network protocol. Switching module 98 may then modify the network protocol setting stored within network protocol setting module 94 to effect the desired change in wireless network protocol.

It should be noted that performance data module 82, performance data storage module 88, and dynamic switching module 92 are reasonably self-contained such that each can be designed, constructed, and updated substantially independently. The present disclosure contemplates implementation of these components (as well as sub-components) as either hardware, software, or a combination of hardware or software for providing the functionality described and illustrated herein.

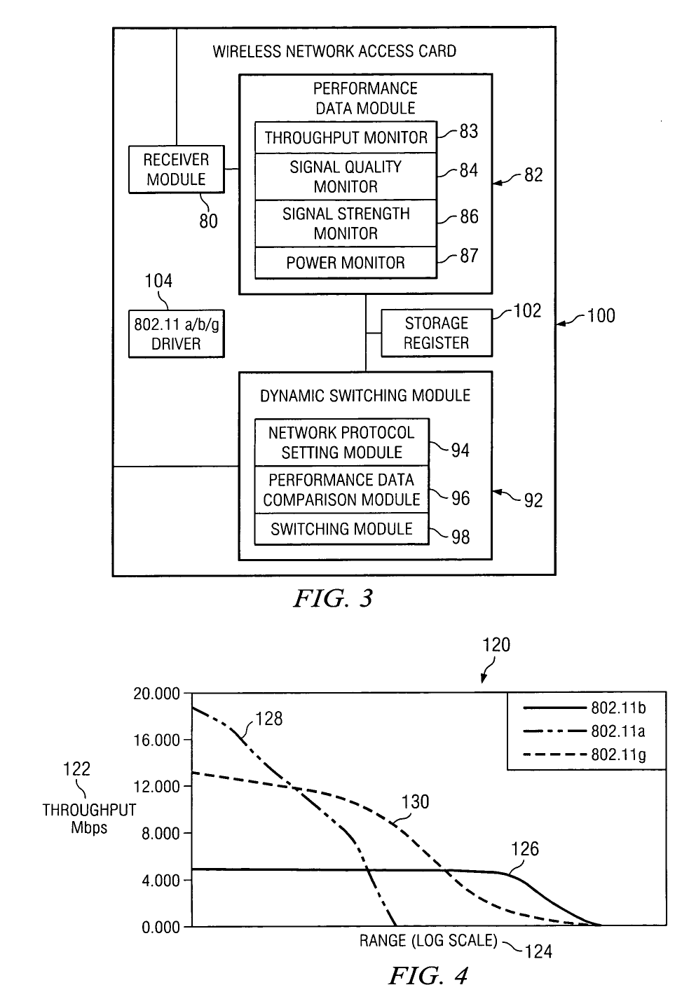

Now referring to FIG. 3, a wireless network access card according to teachings of the present disclosure is shown. Wireless network access card 100 includes several components shown in FIG. 2, integrated into a single card component. In particular, performance data module 82 is shown in communication with receiver module 80. Performance data module 82 is further operable to communicate with register 102 and dynamic switching module 92. Performance data module 82 also includes throughput monitor 83, signal quality monitor 84 signal strength monitor 86 and power monitor 87, as discussed above. In the present embodiment, wireless network access card 100 includes storage register 102 for storing performance information associated with different wireless network protocols. Dynamic switching module 92 includes protocol setting module 94, performance data comparison module 96 and switching module 98 as described above.

In the present embodiment, wireless network access card also includes wireless network protocol driver 104 that is operable to allow wireless network access card to communicate with multiple wireless network protocols. The present embodiment driver 104 allows wireless network access card 100 to communicate according to wireless network protocols 802.11a, 802.11b or 802.11g. In alternate embodiments, driver 104 may allow wireless network access card 100 to communicate with fewer, different or additional wireless network protocols.

Now referring to FIG. 4, a graph showing throughput as a function of range is shown for three different wireless network protocols. Graph 120 shows throughput 122 measured in megabits per seconds (Mbps) as a function of range along algorithmic scale. As shown, the throughput of different wireless communication protocols varies with respect to distance between the client system 10 and the wireless access point from which the protocol communications are being sent or received. As shown, for instance, communications, according to communication protocol 802.11a, have a relatively high throughput at close range, but decrease throughput as the distance between the wireless access point and client system 10 is increased. As client system 10 moves away from the access point, 802.11g eventually provides a higher throughput than 802.11a. As client system 10 moves still further from the access point 802.11b provides the greatest throughput. Accordingly, the most effective communication protocol for a client system 10 will vary based upon the distance between the client system and the wireless access point and can often change during use of a system.

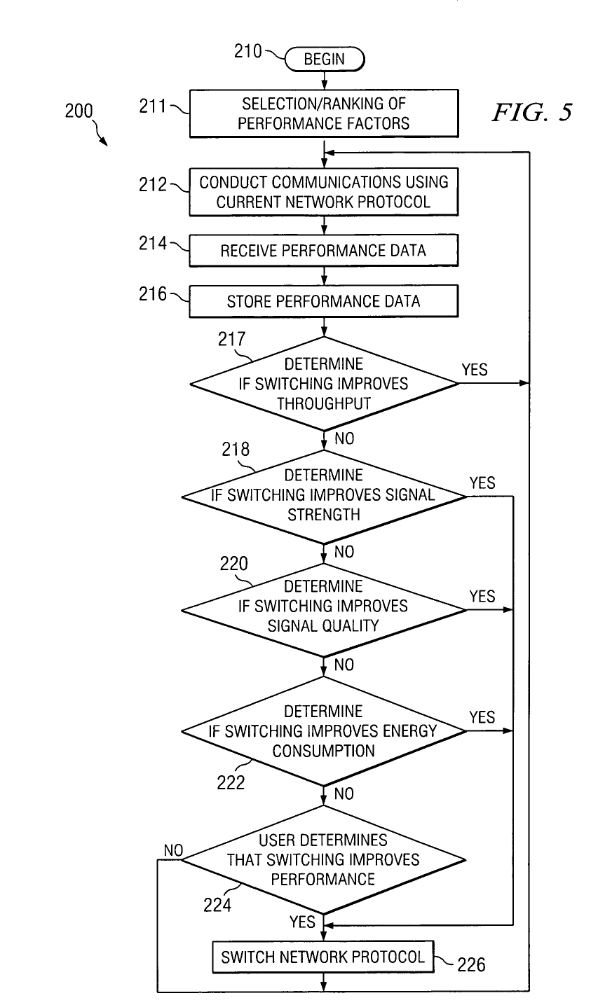

Now referring to FIG. 5, a flow diagram showing a method according to one embodiment of the present disclosure is shown. Method 200 begins at 210. The client system provides a user with the ability to select and/or rank performance factors that will be used in dynamic protocol switching 211. While shown as an initial step in the present embodiment, this step may be providing to the user as a utility, accessible to the user at any time during user of the system. Communications using a current network protocol 212 are analyzed to determine performance data 214, including throughput, signal strength, signal quality, and energy consumption. Next, performance data is stored 216. A determination is then made as to whether switching to a different wireless network protocol will improve throughput 217. If a higher throughput is available from a different network protocol, the method moves to step 226. If not, the method proceeds to step 218. A determination is then made as to whether switching to a different wireless network protocol will improve signal strength 218. If a switch to a different protocol will improve signal strength, the method moves to step 266. However, if switching would not improve signal strength, then a determination is made as to whether to a different network protocol would include signal quality 220. If switching to a different network protocol would include signal quality, the method moves to step 266. However, if switching would improve signal quality, then the method moves to step 222, determining whether switching will improve energy consumption. If switching will improve energy consumption, then the method moves to step 266, switching network protocols.

In the present embodiment if switching would not improve energy consumption, the method moves to step 244, wherein a user may determine that switching may improve performance 244. A user may select to switch to a new wireless network protocol, if not, the method then returns to step 212, conducting communications using the current network protocol. However, if a user selects to switch protocols, the method then moves to step 226, wherein the system would switch to the desired network protocol.

In alternate embodiments, the method may include additional or fewer determination steps. For instance, the present disclosure contemplates using only steps 217, 218, 220 or 222 for determining whether or not the system should automatically switch network protocols 226. Additionally, in alternate systems, a user may be allowed to set which factors the system will consider in determining whether network protocols should be automatically switched. For instance, a user may determine that switching should only based upon a determination of whether switching will improve throughput 217 or energy consumption 22 and not consider the factors of improved signal quality or improved signal strength.

Although the disclosed embodiments have been described in detail, it should be understood that various changes, substitutions and alterations can be made to the embodiments without departing from their spirit and scope.

1. A method for dynamically switching between network protocols, the method comprising:
conducting network communications from a client system via a first network protocol;
receiving, in the client system, performance data for the first network protocol;
receiving, in the client system, performance data for a second network protocol available to the client system;
while conducting network communications with the first network protocol, automatically determining whether switching from the first network protocol to the second network protocol would improve performance for the client system; and
in response to determining that switching to the second network protocol would cause improved performance for the client, automatically switching from the first network protocol to the second network protocol.

2. The method of claim 1, wherein the first network protocol and second network protocol comprise a wireless network protocol selected from the group consisting of 802.11a, 802.11b and 802.11g.

3. The method of claim 1, further comprising:
receiving, in the client system, performance data for a third network protocol available to the client system;
while conducting network communications with the first network protocol automatically determining whether switching from the first network protocol to the third network protocol would improve performance for the client system; and
in response to determining that switching to the third network protocol would cause improved performance for the client, automatically switching from the first network protocol to the third network protocol.

4. The method of claim 1, further comprising:
determining that switching to the second network would cause improved performance based on energy consumption for the client system; and
switching from the first network protocol to the second network protocol.

5. The method of claim 1, further comprising:
storing performance data for the first network protocol and second network protocol in the client system; and
accessing the performance data for the first network protocol and second network protocol.

6. The method of claim 1, wherein performance data for the first network protocol and second network protocol comprises signal quality data.

7. The method of claim 1, wherein performance data for the first network protocol and second network protocol comprises signal strength data.

8. An information handling system for dynamically switching between network protocols, the system comprising:
a receiver module operable to receive communications governed by at least two network protocols;
a performance data module associated with the receiver module, the performance data module operable to obtain network performance data for the at least two network protocols; and
a dynamic switching module associated with the performance data module, the dynamic switching module operable to monitor performance data and dynamically switch between network protocols based on the network performance data.

9. The information handling system of claim 8, further comprising a performance data storage module operable to store performance data, the performance data storage module associated with the performance data module and the dynamic switching module.

10. The information handling system of claim 9, wherein the performance data storage module further comprises at least one register, the register operable to store performance data.

11. The information handling system of claim 8, wherein the dynamic switching module further comprises:
a network protocol setting module operable to identify wireless communications according to the at least two network protocols;
a performance data comparison module operable to compare performance data for the at least two network protocols, and determine if switching to a second network protocol would improve network performance; and
the dynamic switching module operable to switch to a second network protocol if the performance data comparison module determines that switching to a second network protocol would cause improved performance.

12. The information handling system of claim 8, wherein the at least two network protocols comprise wireless network protocols selected from the group consisting of 802.11a, 802.11b and 802.11g.

13. The information handling system of claim 8, wherein the performance data module further comprises a signal quality indicator operable to monitor signal quality associated with communications according to each of the at least two network protocols.

14. The information handling system of claim 8, wherein the performance data module further comprises a signal strength indicator operable to monitor received signal strength of communications according to each of the at least two network protocols.

15. A wireless network access card for dynamically switching between network protocols, the card comprising: a performance data receiver module, operable to receive performance data for communications according to at least two network protocols; and
a dynamic switching module associated with the performance data receiver module, the dynamic switching module operable to monitor and compare performance data of at least two network protocols and dynamically switch network protocols based on performance data.

16. The card of claim 15, the dynamic switching module further comprising:
a network protocol setting module operable to identify wireless communications according to the at least two network protocols;
a performance data comparison module operable to compare performance data for the at least two network protocols and determine if switching to a second network protocol would improve performance; and
the dynamic switching module operable to switch to a second network protocol if the performance data comparison module determines that switching to a second network protocol would cause improved performance.

17. The card of claim 15, further comprising at least one storage register, the storage register associated with the performance data receiver module and the dynamic switching module and operable to receive performance data from the performance data receiver module and provide performance data to the dynamic switching module.

18. The card of claim 15, wherein the performance data receiver module further comprises:
a signal quality indicator operable to monitor signal quality associated with communications according to each of the at least two network protocols; and
a signal strength indicator operable to monitor received signal strength associated with communications according to each of the at least two network protocols.

19. The card of claim 15, wherein the at least two network protocols comprise wireless network protocols selected from the group consisting of 802.11a, 802.11b and 802.11g.

20. The card of claim 15, further comprising a receiver module operable to receive communications governed by the at least two network protocols
